(19) United States
(12) Patent Application Publication
(10) Pub. No.: US 2003/0233287 A1
(43) Pub. Date: Dec. 18, 2003

(54) Internet-based apparatus and method of tracking and reporting assets

(76) Inventors: Dean Sadler, Sheffield (GB); Lee Strafford, Sheffield (GB); Matt Grest, Sheffield (GB); Joel Borovay, Paradise Valley, AZ (US)

Correspondence Address: QUARLES & BRADY LLP, RENAISSANCE ONE, TWO NORTH CENTRAL AVENUE, PHOENIX, AZ, 85004-2391, US

(21) Appl. No.: 10/167,829

(22) Filed: Jun. 12, 2002

(51) Int. Cl. G06F 17/60

(52) U.S. Cl. 705/28

(57) ABSTRACT

An internet-based method of tracking and reporting assets on an asset management system is provided with a server (20) connected to the internet. A plurality of software modules (22-30) execute on the server. Each of the software modules provides a function to track and report the assets on the internet-based asset management system. The users gain access to the software modules through the internet. The asset management system appears as web pages available through the world wide web. The software modules provide the ability to add and update an asset on the asset management system, add employee information to the asset management system and update the asset with the employee information, create an asset tag containing asset information, and generate a report based on the asset information.

### FIELD OF THE INVENTION

The present invention relates in general to a method of tracking and reporting assets and, more particularly, to an internet based method of tracking and reporting assets.

### BACKGROUND OF THE INVENTION

Companies, businesses, partnerships, governments, universities, and individuals own, lease, rent, and possess a variety of assets to conduct and manage their business and perform other useful and necessary activities. The assets can take the form of virtually any tangible or intangible object or item. For example, an asset may be (1) a computer, (2) a computer component such a hard disk or memory module, (3) a computer peripheral such as a printer or fax machine, (4) software or application program resident on the computer, and (5) license, agreement, or right to use other assets. Assets can also be (1) vehicles, (2) inventory, (3) manufacturing equipment, (4) office fixtures, (5) employee and customer information, (6) business plans, (7) options and rights to exercise, and (8) any other item that can be identified, tracked, and managed.

Most, if not all, assets must be identified, tracked, and managed for accounting, security, safety, auditing, reporting, planning, and tax purposes. It is important to know detailed information about the assets, e.g. description of the asset, identification or designations, location of the asset, date placed in service, custodian, original value and depreciation schedule, length of service life expectancy, maintenance history, notes, warnings, and other relevant information. Such information and data must be collected, recorded, updated, and managed in a manner that allows for accurate and effective use for the stated and intended purposes.

Historically, asset tracking and reporting has been a costly, time consuming, error-prone, burdensome task. Typically, individuals gather the data by physically going to each location, room-by-room, office-by-office, item-by-item, and manually identify and collect information about each asset. The information and data is entered into a database, log book, computer system, or other recording medium. Sometimes the same asset information is collected by different individuals and departments and recorded in different formats, on different mediums, and in different locations, and maintained under the control of different asset management groups, each with their own requirements, obligations, and agenda. The same data, or overlapping data, may be kept on a stand-alone personal computer by one group, in a hand-written log book by another group, and on a network server by a third group. One should not assume that any one group knows or cares what another group is doing. Sometimes the department, agency, or person receiving the report will require specific or special information in a particular format, which is often different than other reporting requirements.

When the asset acquires new attributes, moves location, changes ownership, or otherwise when the collected information is no longer accurate, then the data collecting, recording, and reporting process must be repeated. Asset management, tracking, and reporting systems as found in the prior art have one or more of the disadvantages of being non-centralized, inconvenient, narrowly focused, inflexible, time consuming to collect and record the data, and expensive. Moreover, without dedication and careful attention to detail, the asset data and information becomes inaccurate which defeats a primary purpose of the asset management system.

As mentioned above, one common example of a prior art asset management system is a database and application program resident on a local network server. The local server is accessible via a number of personal computers connected to the server network. Once the asset information and data is collected, it is recorded on the server and available to authorized sites and users.

The local network server-based asset management system is expensive in terms of the purchase and maintenance of the server, or at least dedication of a portion of server resources, and associated software and applications. The server must be backed-up on regular intervals. The asset data and information may still be manually collected and manually updated. The local server must be maintained by skilled professionals. The database is accessible only to sites, computers, and users properly connected to and authorized through the server network. Some server network firewalls are rather slow, complicated to get through, and susceptible to communication and hardware errors. Some companies and users simply do not have and cannot afford the cost of high-reliability, bullet-proof servers and applications. If the local server is down, which is not uncommon, the asset data and information is completely unavailable. Server down time seems to directly coincide with the time of most critical need for the asset information.

Users demand a large number of features and flexibility from asset tracking and reporting tools to meet their individual needs. While there exists several commercial asset tracking and reporting tools in the prior art, none have achieved a total solution for the user's needs. Many are local network server based. Most, if not all, offer the ability to add and change assets. However, one tool may offer custom field creation, but no data export feature. Another tool may offer asset depreciation, but no ability to track software licenses. Many other desirable features are missing from known commercial asset tracking and reporting tools.

A need exists for an asset tracking and management system which provides easy accessibility, high reliability, centralization of data, and an extensive and flexible portfolio of features and capabilities.

### BRIEF DESCRIPTION OF THE DRAWINGS

FIG. 1 is a block diagram illustrating an asset management system;

FIG. 2 illustrates the software modules executing the features and capabilities of the asset management system;

FIG. 3 illustrates a main web page of the asset management system;

FIG. 4 illustrates a web page to view assets by location; and

FIG. 5 illustrates a web page to add an asset into the asset management system.

### DETAILED DESCRIPTION OF THE DRAWINGS

An asset management system 10 is shown in FIG. 1. User 12, user 14, and user 16 are each connected to an internet communication network 18. Users 12, 14, and 16 each represent a company, business, partnership, government entity, university, individual, or other entity that owns, leases, rents, and possesses assets. Users 12-16 each independently connect to an internet communication network 18 by any computer or other communication system having a modem or other suitable communication link. Internet communication network 18 may be the world wide web or other open communication network. Asset management server 20 represents a computer server or computer system, which is also connected to internet communication network 18. Asset management server 20 can be a centralized server or computer system, or a distributed computer system existing at multiple locations.

Asset management server 20 is controlled and maintained by an asset management service provider. The asset management service provider is responsible for the maintenance, upgrades, backup, and integrity of asset management server 20. Users 12-16 interface and communicate with asset management server 20 via internet communication network 18. Thus, the users can access, add to, change, report, and perform other functions on their asset data from any location and any computer that has a modem connection or other high-speed communication link to the internet. Internet communication network 18 provides a high reliability, robust communication link. The users can customize the asset management system that they use and have access to by purchasing the desired features from a pool of available software modules, as described hereinafter, offered by the asset management service provider and selectable by the user. Each user 12-16 thus has their own separate and independent, selectable and customized asset management system on asset management server 20.

Asset management system 10 tracks and reports on the assets of each user 12-16. Many assets must be identified, tracked, and managed for accounting, security, safety, auditing, reporting, planning, and tax purposes. The assets can take the form of virtually any tangible or intangible object or item which users 12-16 utilize to conduct and manage their business and perform other useful and necessary activities. For example, an asset may be (1) a computer, (2) a computer component such a hard disk or memory module, (3) a computer peripheral such as a printer or fax machine, (4) software or application program resident on the computer, and (5) license, agreement or right to use other assets. Assets can also be (1) vehicles, (2) inventory, (3) manufacturing equipment, (4) office fixtures, (5) employee and customer information, (6) business plans, (7) options and rights to exercise, and (8) any other item that can be identified, tracked, and managed.

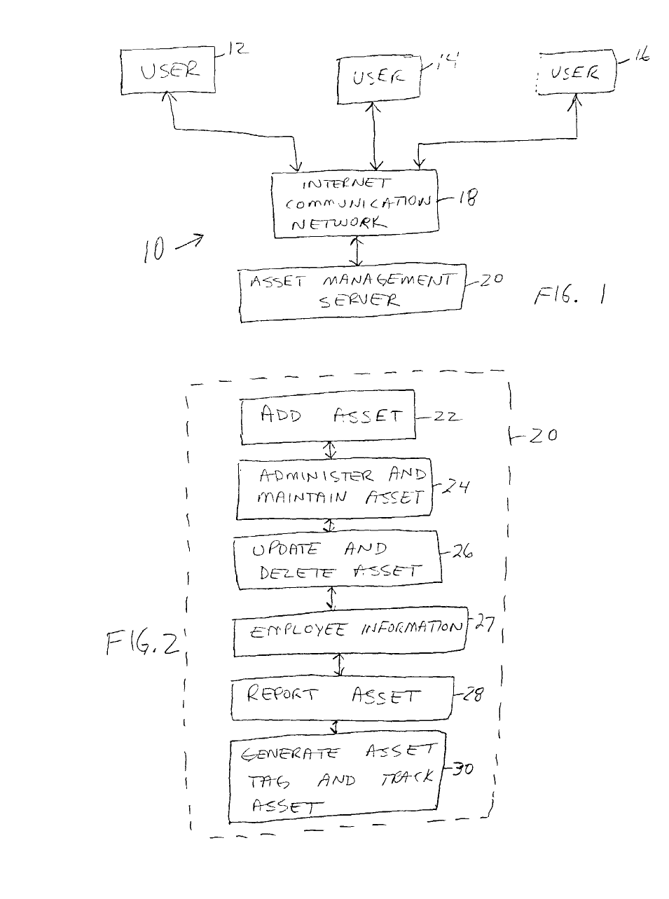

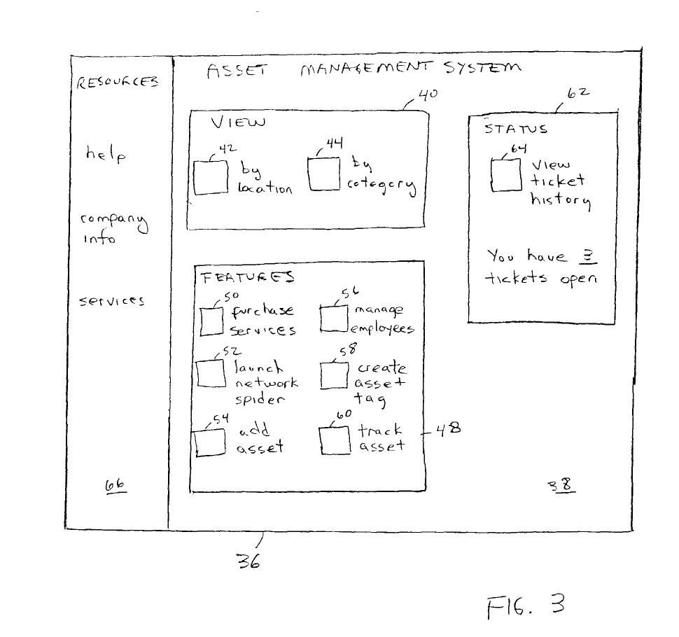

Some useful features of asset management system 10 are shown in FIG. 2. The method of tracking and reporting assets as described herein may be performed as a plurality of software modules executing on a computer having a microprocessor, memory, hard disk drive, and other peripheral. The computer executing the software modules is asset management server 20.

In software module 22, an asset is added to the asset database or data structure of asset management system 10. An asset can be added by a number of methods. The assets can be manually input by an operator typing the asset data into fields on a data entry screen. The assets can be input by network or local spiders, which are application programs that search the network or local machine identifying resident assets. The spiders compile asset data into a data file, which is then imported into asset management system 10.

In software module 24, an asset, which is existing in the asset database or data structure of asset management system 10, is administered and maintained. The user can assign an asset to a specific cost center, i.e. location or area known by the user's accounting system. For example, the user can set up separate campuses or locations and allocate each asset to a particular campus or location. The resolution of definable locations can be as fine as the user needs, e.g. a specific country, city, building, office, or even a specific drawer, shelf, or file folder, thereby providing maximum flexibility in design and implementation. The asset can be readily moved from one cost center to another. In administering and maintaining the assets, asset management system 10 allows the user to (1) view assets in a number of orientations and formats, (2) purchase additional features and services from the asset management service provider, (3) configure products purchased from other vendors, and (4) automatically populate their own custom asset management system with newly purchased features and services as well as those that have been previously purchased.

In software module 26, an asset, which is existing in the asset database or data structure of asset management system 10, is updated or deleted. The update can be performed much as described for adding an asset, except that the prior asset record is overwritten instead of a new asset record being created. When an asset record is deleted, it is disposed of through a recycle bin which allows easy retrieval if the deletion was unintended or if the user changes their mind.

In software module 27, employee information is entered and maintained and can be automatically related to any asset. As described below, each asset may be assigned a custodian or owner of the asset. Rather than entering the employee information for each asset, the system can assess the employee database and automatically attached the asset to the responsible person. The employee database is integrated with and extracted from the user's human resource (HR) computer system to avoid duplicative efforts and to have access the most up-to-date employee information. Having the employee information in one place simplifies the add/update asset operation.

In software module 28, an asset, which is existing in the asset database or data structure of asset management system 10, is reported. The reports, as described below, have certain canned formats and allow for customized or user-defined formats. The asset data can also be exported to other application programs, such as a spread sheet, for additional reporting capability.

In software module 30, an asset, which is existing in the asset database or data structure of asset management system 10, has an asset tag created for it. An asset tag is a printed label, with some basic asset identifying information and possibly a universal product code (UPC) bar code. The asset tag is generated on an adhesive backed label to be applied directly to the physical asset. A tracking identification number is assigned to each asset for ready access.

Accessing asset management system 10 is easy and convenient. All the user needs is a computer with a web browser and an internet communication link. Asset management system 10 is accessible from any internet enabled location. There are no local hardware servers, software dependencies, or maintenance requirements for the user to access the asset management system. Thus, the user has very minimal deployment costs.

The user may be in their office, at home, in a hotel room in any city, in the airport, anywhere there exists a communication link. The user turns on their personal computer from any location and, if necessary, plugs the computer modem into a telephone line. Next, the user starts their favorite web browser program and makes connection over the communication link to the internet. The user enters a website address of the asset management service provider, e.g. www.nsitservices.com, and an introductory, welcome log-in web page (not shown) appears on the screen. The users enters their log-in name and password, which routes them to a web page set up for their own asset management system.

Asset management system 10 uses an authentication protocol transmitted by encrypted secure hypertext transfer protocol (HTTPS) from a named static internet protocol (IP) address. Authentication will not be successful unless the log-in name and password passes only between the user and the asset management service provider with the correct encryption method. Accessing asset management system 10 through the internet is convenient, easy to use, highly reliable, robust, safe, secure, and globally accessible.

An advantage of asset management system 10 is that the asset management service provider maintains the website and the hardware and software on asset management server 20. By going through the website, the user will always have access to the latest version of asset management software. The asset data is centralized on asset management server 20 so even different departments or groups under each user go to one source for their asset data. The asset management service provider also backups the data and information and maintains the integrity of asset management server 20.

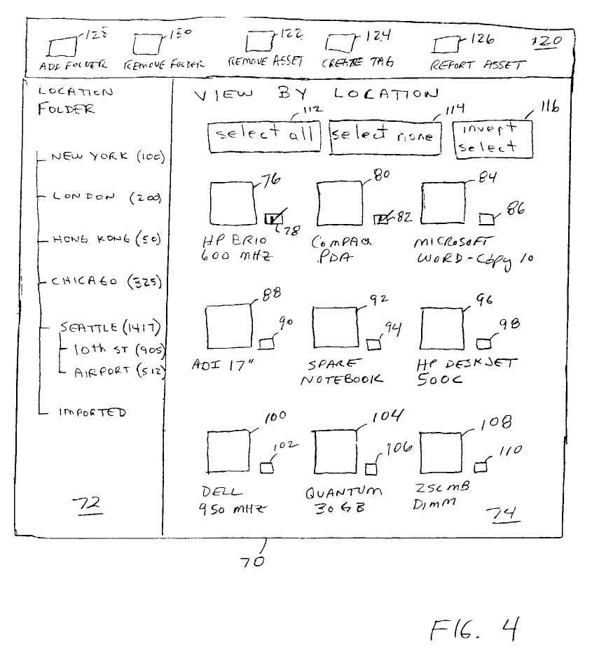

Once past the log-in page, a web page 36, such as shown in FIG. 3, configured according to their own asset management system and purchased software modules appears on the screen. ASSET MANAGEMENT SYSTEM box 38 of web page 36 includes VIEW box 40. Inside VIEW box 40, there is an icon 42 with associated label “by location” and an icon 44 with label “by category.” Any icon described herein can be selected and activated by pointing and clicking the mouse on the icon. Alternatively, the user can use the tab key to tab down to the desired icon and then press the enter key. Each icon is a hyperlink to other web pages and additional information. FEATURES box 48 includes icon 50 with label “purchase services”, icon 52 with label “launch network spider”, icon 54 with label “add asset”, icon 56 with label “manage employees”, icon 58 with label “create asset tag”, and icon 60 with label “track asset.” The icons represent hyperlinks to software modules to perform the task of managing the assets. STATUS box 62 includes icon 64 with label “view ticket history.” STATUS box 62 also provides information about the number of open service or maintenance tickets. To the left of the main section of web page 36 is a RESOURCES box 66 with hyperlinks to “help”, “company info”, and “services.”

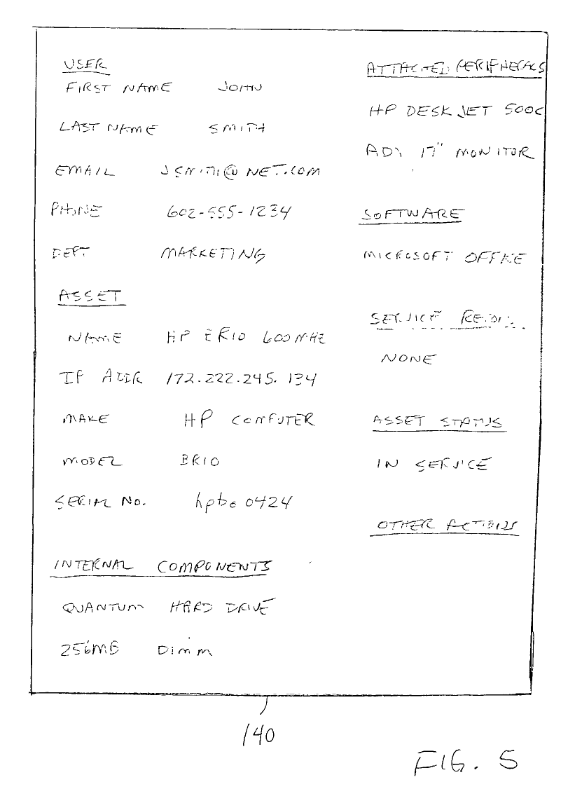

Selecting icon 42 takes the user to web page 70 as shown in FIG. 4. In LOCATION FOLDER box 72, the user sees a hierarchical directory of all locations where assets are located. Each location label is a folder with asset data and information located inside. The location label also shows the number of assets in that location. For example, “New York” has 100 assets, “London” has 200 assets, “Hong Kong” has 50 assets, “Chicago” has 325 assets, and so on. Location label “Seattle” with 1417 total assets has subfolders “10th St” and “Airport” with 905 assets and 512 assets, respectively.

The user selects one of the location labels in LOCATION FOLDER box 72, e.g. “New York”, and the selected asset data and information appears in VIEW BY LOCATION box 74. Each asset is given an icon and individual select box. A first asset, e.g. an HP Brio 600 MHz computer, is shown as icon 76 in the representative image of a computer. The user selects the first asset by pointing and clicking on icon 76. Alternatively, the user can pre-select icon 76 by checking selection box 78. Pointing and clicking selection box 78 places a check mark in the box as shown. A second asset, e.g. a Compaq PDA, is shown as icon 80 with a representative image. The user selects the second asset by pointing and clicking on icon 80, or by pre-selecting it by checking selection box 82. Pointing and clicking selection box 82 places a check mark in the box as shown. The third through ninth assets are assigned to representative icons 84, 88, 92, 96, 100, 104, and 108, respectively. Selection boxes 86, 90, 94, 98, 102, 106, and 110 are provided for pre-selecting icons 84, 88, 92, 96, 100, 104, and 108, respectively. The user selects the third through ninth asset by pointing and clicking on its icon, or by checking its selection box. Additional assets may be viewed by using a scroll bar (not shown).

The user may also select all assets by pointing and clicking on select all box 112, or select none of the assets by pointing and clicking on select none box 114, or invert the selection of assets by pointing and clicking on invert select box 116.

If the user selects only one asset by pointing and double clicking on its icon, then detailed data and information appears for that asset for viewing and updating. If the user pre-selects certain assets by placing checks in one or more selection boxes, then the user may select one of the actions shown in action box or toolbar 120. For example, pointing and clicking on remove asset icon 122 will remove the pre-selected assets from the asset database or data structure of asset management system 10. Pointing and clicking on create tag icon 124 will create asset tags for the pre-selected assets. Pointing and clicking on report asset icon 126 will create a report for the pre-selected assets.

Also within toolbar 120 is add folder icon 128 and remove folder icon 130 for adding folders, removing folders, and performing other management operations on LOCATION FOLDER box 72. Other action icons, such as rename folder, add asset, cut, paste, view, employees, tracking, and exporting can be placed in toolbar 120.

Returning to FIG. 3, view by category icon 44 sorts the assets by category instead of location, but otherwise provides the same hierarchical directory and same asset data and information and same available actions as described in FIG. 4. Examples of asset categories include computers, printers, software applications, or any other logical or related grouping of the assets. New locations and asset categories can be created and hierarchically nested to any number of levels. This feature provides flexibility to make the asset management system work with the user's business.

Asset management system 10 offers a large number of services and allows the user to select and purchase only those features and services they need to track and report assets for their business. The features and services are provided on individual software modules which the user can select to match their needs. Purchase services icon 50 in FEATURES box 48 allows the user to add and delete asset management services as their needs change. For example, the user may originally configure asset management system without the depreciation and accounting software module. Later, the user may find a need for such a feature. The users points and clicks on purchase services icon 50 and a web page (not shown) appears showing existing services already purchased by the user and other services which are available for purchase. The user points and clicks on the new services, or de-selects services they no longer need. Their own personal asset management system is updated with the new service configuration. The user may also purchase add-on features such as a warranty or maintenance agreement for an existing asset. Asset management system 10 keeps track of the user's account and bills the user according.

Asset management system 10 provides an easy method of adding assets to the asset database or data structure. Icon 52 launches the network spider. The network spider is an application program which queries a given range of IP addresses. The network spider polls each IP address, collects asset data and information, and consolidates the information into a data file under an extensible markup language (XML) format. Asset management system 10 imports the data file to add, delete, and update the asset records on asset management server 20.

Selecting launch network spider icon 52 in FEATURES box 48 takes the user to another web page (not shown). The network spider web page informs the user of the IP address of the present computer and other network information, such as host capacity, sub-divisions of host, and option to scan other subnets. The general format of an IP address is “tree.trunk.branch.node”. A search box appears for the user to enter the name and directory location of the output data file and the starting IP address and ending IP address for the network spider to search. The starting IP address may be “195.166.137.1” and the ending IP address may be “195.166.137.254”. If the user operates any one of the publicly accessible lightweight directory access protocol (LDAP) servers, then the network spider will poll each IP address and return data and information related to any assets it finds. The network spider will identify computers, printers, and other assets connected to the network within the specified IP address range. If the user does not use an LDAP server, then the network spider can be downloaded and executed from the user's computer.

The network spider is typically limited to the network interface of each asset. A network interface is, for example, the Ethernet card in a computer or network card in a globally shared printer. The network spider may not be able to collect information beyond the network interface. Therefore, while the network spider will find a computer connected to the network, it may not be able to see inside the computer and determine its components, e.g. hard drive, memory, and microprocessor.

To collect data and information about assets which the network spider cannot detect, asset management system 10 provides a local or client-based spider. The local spider is an application program which is resident on the asset, for example, a personal computer. The local spider can detect internal assets such as hard drive, memory, cards, and application programs. The local spider queries the internal assets of the resident system, collects asset data and information, and consolidates the information into a data file. Asset management system 10 imports the data file to add, delete, and update the asset records.

Some custom or non-commercial software may not be recognizable at first. The unrecognized internal components or software are reported for manual data entry. Asset management system 10 includes a software tutor which learns to recognize non-standard software or other components. Once the user teaches the system about a particular software module or other component, the local spider will recognize the asset during subsequent runs. The local spider can be configured to run at regular intervals, e.g. every night or at boot-up, to maintain up-to-date data and information about the user's assets.

Add asset icon 54 in FEATURES box 48 provides a feature to manually enter data and information related to an asset. Selecting add asset icon 54 takes the user to a web page 140 such as shown in FIG. 5. The user can enter information about the user or custodian such as name, email, phone, and department. Next, the user enters information about the asset, such as name, IP address, make, model, and serial number.

An asset may have relationship(s) with other assets. The other asset can be a component, i.e. internal to the subject asset. For example, a computer asset will have internal component of a hard disk drive and memory module. The internal components of an asset generally follow the asset as it moves from location to location. The other asset can be a peripheral, i.e. external but attached to the subject asset. For example, a computer may have an attached printer. The peripherals of an asset may but do not necessarily follow the asset as it moves from location to location. Some assets can be both a component and a peripheral. A docketing station may be a component for a laptop but a peripheral to a desktop computer. Asset management system 10 tracks these relationships and related assets.

In web page 140, the user can enter information about internal components. The internal components include hyperlinks to their principal asset information. The user can also enter information about attached peripherals. The peripheral assets include hyperlinks to their principal asset information. The user enters data and information about resident software installed on the asset. The software tracking is useful for software license tracking as required by some software vendors. Finally, the user enters information about the service record of the asset and its status. The service record will include information such as warranty claims and open service tickets. The user may assign an asset status such as normal, under repair, scheduled for delivery, or other user-defined status.

Web page 140 includes an other action area where the user is provided an opportunity to attach a peripheral, attach an internal component, organize assets, add software, and view/edit details. Any manual edits and updates to the asset data and information can be performed on a web page similar to web page 140. Assets can easily be moved between custodians and locations. Assets with associated internal components are moved or changed as well. The user is prompted as to whether to also move or change the associated peripherals. Asset management system 10 provides a number of data fields, not all of which are shown in FIG. 5. Each of the web pages can provide customized or user-defined information fields.

Asset management system 10 can communicate directly with suppliers and vendors. The user can purchase new assets from predetermined vendors and suppliers from within the system. When the user orders new equipment, the supplier can provide the asset data and information directly into asset management system 10 thereby reducing the effort to keep up with all the new incoming assets.

Manage employees icon 56 in FEATURES box 48 provides a feature to manually enter data and information related to employee who may be assigned as a user or custodian of any asset. Selecting manage employees icon 56 takes the user to a web page (not shown) to enter employee information such as described under the user area on web page 140. Providing the employee information in one place simplifies the add/update asset operation. The user can type in partial employee information and the system will add the rest, or the user can select from a list of employee data. Indeed, asset management system 10 can be configured for seamless integration with the user's HR department and share data with the HR computer system. Asset management system 10 will always have the latest information, or at least be coordinated with the HR department.

Create asset tag icon 58 in FEATURES box 48 provides a feature to create asset tags related to one or more assets. Selecting create asset tag icon 58 takes the user to a web page similar to web page 70 in FIG. 4. The user selects which assets to make asset tags. Asset management system 10 then creates asset tags that can be printed on adhesive backed paper. A tracking ID number is also generated for the asset. The asset tag will provide information such as tracking ID, employee, IP address, asset title, asset description, phone number, and service contact information. The asset tag may also have a UPC bar code label. The asset tags can be attached to or installed on the physical asset.

Once an asset tag is created for an asset, track asset icon 60 in FEATURES box 48 provides a feature to track the asset. The user can select a tracking ID and readily find information related to the asset in the system.

Asset management system 10 offers a variety of reporting capabilities in the system. The user can select and report on assets by location, by user, by status, by category, and by asset/service relationships. The reporting feature retrieves the specified data, sorts it, and reports it in a tabular format. The user may also customize reports by selecting on the desired information and the sort criteria.

Assets can be selected and grouped by the user, and their data and information converted to a variety of formats for export to other applications for reporting and visibility purposes. The other application, such as a spread sheet or powerpoint presentation, can report on the assets according to its capabilities.

Asset management system 10 also offers depreciation and accounting capabilities as a software module. The assets are assigned an initial value and a depreciation schedule from which the present value of the asset is readily determined. The accounting package provides information in accordance with generally accepted accounting principals.

The software license tracking software module is useful when the user must report on various software licenses. The local spider will identify software assets. The system will maintain information as which software module is resident on which computer. The titles, copies, and versions can be readily tracked and reported.

Although the present invention has been described with respect to preferred embodiments, any person skilled in the art will recognize that changes may be made in form and detail, and equivalents may be substituted for elements of the invention, without departing from the spirit and scope of the invention. Therefore, it is intended that the invention not be limited to the particular embodiments disclosed for carrying out this invention, but that the invention will include all embodiments falling within the scope of the appended claims.

What is claimed is:

1. A method of tracking assets, comprising:
providing a server connected to an open communication network;
executing a plurality of software modules on the server, wherein each of the plurality of software modules provides a function for tracking assets on an asset management system; and
providing user access to the plurality of software modules through the open communication network.

2. The method of claim 1, wherein the plurality of software modules are user-selectable.

3. The method of claim 1, wherein the open communication network is an internet.

4. The method of claim 1, wherein the user access to the server is provided through a web page.

5. The method of claim 1, wherein the step of executing a plurality of software modules includes:
providing a first software module to add an asset to the asset management system; and
providing a second software module to maintain an asset in the asset management system.

6. The method of claim 1, wherein the step of executing a plurality of software modules includes providing a software module to add employee information to the asset management system and update the asset with the employee information.

7. The method of claim 1, wherein the step of executing a plurality of software modules includes providing a software module to create an asset tag containing asset information.

8. The method of claim 1, wherein the step of executing a plurality of software modules includes providing a software module to generate a report based on asset information.

9. A method of tracking and reporting assets on an internet-based asset management system, comprising:
providing a server connected to an internet communication network;
executing a plurality of software modules on the server, wherein each of the plurality of software modules provides a function to track and report the assets on the internet-based asset management system; and
providing user access to the plurality of software modules through the internet communication network.

10. The method of claim 9, wherein the user access to the server is provided through a web page.

11. The method of claim 9, wherein the step of executing a plurality of software modules includes:
providing a first software module, to add an asset to the asset management system; and
providing a second software module to maintain an asset in the asset management system.

12. The method of claim 9, wherein the step of executing a plurality of software modules includes:
providing a first software module to add employee information to the asset management system and update the asset with the employee information;
providing a second software module to create an asset tag containing asset information; and
providing a third software module to generate a report based on the asset information.

13. An asset management system, comprising:
a server connected to an open communication network;
a plurality of software modules executing on the server, wherein each of the plurality of software modules provides a function to track assets on an asset management system; and
means for providing user access to the plurality of software modules through the open communication network.

14. The asset management system of claim 13, wherein the open communication network is an internet.

15. The asset management system of claim 13, wherein the user access to the server is provided through a web page.

16. The asset management system of claim 13, wherein the step of executing a plurality of software modules includes:
a first software module to add an asset to the asset management system; and
a second software module to maintain an asset in the asset management system.

17. The asset management system of claim 13, wherein the step of executing a plurality of software modules includes:
a first software module to add employee information to the asset management system and update the asset with the employee information;
a second software module to create an asset tag containing asset information; and
a third software module to generate a report based on the asset information.

18. A method of tracking assets on an asset management system, comprising:
providing a server connected to an internet communication network;
providing a plurality of software modules on the server, wherein each of the plurality of software modules executes a function for tracking assets on the asset management system; and
providing user access to the plurality of software modules through the internet communication network.

19. The method of claim 18, wherein the user access to the server is provided through a web page.

20. The method of claim 18, wherein the step of executing a plurality of software modules includes:
providing a first software module to add an asset to the asset management system; and
providing a second software module to maintain an asset in the asset management system.

21. The method of claim 18, wherein the step of executing a plurality of software modules includes:
providing a first software module to add employee information to the asset management system and update the asset with the employee information;
providing a second software module to create an asset tag containing asset information; and
providing a third software module to generate a report based on the asset information.
